(19) United States
(12) Patent Application Publication
(10) Pub. No.: US 2025/0378640 A1
(43) Pub. Date: Dec. 11, 2025

(54) STORAGE DATA STRUCTURES FOR USE WITH LARGE-SCALE VOLUMETRIC MODELS

(71) Applicant: Foresight Spatial Labs Corporation, Ottawa (CA)

(72) Inventors: Duncan Robert Fairbanks, Seattle, WA (US); Sebastien Nicolas Crozet, IIe-de-France (FR); Julian Ramirez Ruiseco, Ottawa (CA); Riccardo D’Ambrosio, Tampa, FL (US)

(21) Appl. No.: 18/736,193

(22) Filed: Jun. 6, 2024

(51) Int. Cl. G06T 17/20; G06T 17/00

(52) U.S. Cl. CPC G06T 17/20; G06T 17/005

(57) ABSTRACT

Approaches presented herein provide database formats for storing large-scale three-dimensional (3D) models for streaming and constructive solid geometry operations. The storage structure may include a Directed Acyclic Graph (DAG), with each root of the DAG uniquely identifying a 3D model. A tree spanning the DAG starting at a root forms a hierarchical representation of that model, including a series of levels of detail along with associated shards. The model may also include nodes with node attributes that may be stored in a column and row structure to facilitate retrieval of individual attributes to enable selective loading of portions of the models.

### BACKGROUND

Existing block-based systems for representing volumetric models are often limited to grid-aligned (e.g., voxel) representations. However, for certain representations, such as land masses, mines, construction sites, and other real world structures, grids provide a limitation for accurately representing topologies, which causes trade-offs between storage, computation times, and accuracy. Grid accuracy may be directly proportional to the grid size, and therefore, smaller grids with more intricate details may lead to volumes that are represented by larger numbers of voxels, potentially billions for large representations, creating storage and rendering problems. When a user wishes to execute some operation on the model, such as to render the model for viewing or to perform some types of geometric workloads, the large model sizes may be difficult to transmit, store, and then use. This may be exacerbated when users attempt to obtain models from cloud-based storage and/or when users are at locations where network connectivity may be poor.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings. In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from spirit or scope of the subject matter presented here. In some drawings, various structures according to embodiments of the present disclosure are schematically shown. However, the drawings are not necessarily drawn to scale, and some features may be enlarged while some features may be omitted for the sake of clarity. It will be readily understood that the aspects of the present disclosure, as generally described herein, and illustrated in the figures, can be arranged, substituted, combined, and designed in a wide variety of different configurations, all of which are explicitly contemplated and make part of this disclosure. As noted above, the drawings as depicted are not necessarily drawn to scale. The relative dimensions and proportions as shown are not intended to limit the present disclosure, unless indicated otherwise. Various embodiments in accordance with the present disclosure will be described with reference to the drawings, in which:

FIG. 1 illustrates an example environment of a series of models updates over a period of time, according to at least one embodiment;

FIG. 2 illustrates an example tree structure for storing a volumetric model, according to at least one embodiment;

FIG. 3 illustrates an example store structure between two models sharing a partition, according to at least one embodiment;

FIG. 4 illustrates an example geometry file representing nodes and associated attributes at different levels of detail, according to at least one embodiment;

FIG. 5 illustrates an example environment for rendering and performing computational operations on a volumetric model, according to at least one embodiment;

FIG. 6 illustrates an example environment for rendering a selected portion of a volumetric model, according to at least one embodiment;

FIG. 7A illustrates an example process for generating a tree structure for storing a volumetric model, according to at least one embodiment;

FIG. 7B illustrates an example process for mapping shared model features within a shared partition, according to at least one embodiment;

FIG. 8 illustrates an example process for generating an attribute shard file and using the attribute shard file for one or more operations on a volumetric model, according to at least one embodiment; and

FIG. 9 is an example configuration for a computing device, in accordance with embodiments of the present disclosure.

### DETAILED DESCRIPTION

The foregoing aspects, features, and advantages of the present disclosure will be further appreciated when considered with reference to the following description of embodiments and accompanying drawings. In describing the embodiments of the disclosure illustrated in the appended drawings, specific terminology will be used for the sake of clarity. However, the disclosure is not intended to be limited to the specific terms used, and it is to be understood that each specific term includes equivalents that operate in a similar manner to accomplish a similar purpose.

When introducing elements of various embodiments of the present disclosure, the articles “a”, “an”, and “the” are intended to mean that there are one or more of the elements. The terms “comprising”, “including”, and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “an embodiment”, “certain embodiments”, or “other embodiments” of the present disclosure are not intended to be interpreted as excluding the existence of additional embodiments that also incorporate the recited features. Furthermore, reference to terms such as “above”, “below”, “upper”, “lower”, “side”, “front”, “back”, or other terms regarding orientation or direction are made with reference to the illustrated embodiments and are not intended to be limiting or exclude other orientations or directions. It should be further appreciated that terms such as approximately or substantially may indicate +/−10 percent.

Approaches in accordance with various illustrative embodiments provide improvements for storage, streaming, rendering, and use of volumetric models (e.g., three-dimensional (3D) models). In at least one embodiment, systems and methods may include a distributed bounding volume hierarchy (BVH) forming a shallow directed acyclic graph (DAG) for shared linear BVHs, with each root of the shallow DAG used to identify a unique 3D model. The DAG may be in the form of a tree-structure with an established hierarchical representation based on levels of detail. In at least one embodiment, leaves contain model primitive geometries while internal nodes contain the bounding volumes of associated children. In at least one embodiment, each primitive is associated with one or more attributes, with each attribute being stored with respect to a given node on a per-attribute basis. Accordingly, systems and methods may be used to render or execute operations for different levels of detail on a per-attribute basis.

Various embodiments of the present disclosure may be used to store incremental modifications of one or more models over a lifetime of the model. For example, when particular data chunks for a model are modified, a new model may be saved including the modified data chunks while maintaining references to previously stored, unmodified data chunks. As a result, storage of new models may be reduced because instead of re-saving an entire model, the new model may share a partition with a previous model by referring to previously stored data while maintaining newly modified data.

Systems and methods of the present disclosure may address and overcome problems associated with existing storage solutions, such as storage for large volumetric models. In at least one embodiment, embodiments provide implicit deduplication between models by storing modifications and then sharing information between models. Embodiments may also enable more representation configurations, and not just grid representations as limited by prior systems, and may further be extended to a variety of different volumetric geometries, including voxels, point clouds, and/or the like. Systems and methods may also be used for efficient mathematical iterations on the stored data by enabling division and/or slicing of the model for particular operations instead of using the entire model. As a result, complexity of the operations may be segment-based and not based on the model as a whole. Embodiments may further store attributes for particular nodes of the model on a per-attribute basis, thereby permitting rendering and operations by attribute. Furthermore, systems and methods may deploy various levels of detail (LoD) for rendering and other operations by selectively down sampling different regions of the model.

Variations of this and other such functionality can be used as well within the scope of the various embodiments as would be apparent to one of ordinary skill in the art in light of the teachings and suggestions contained herein.

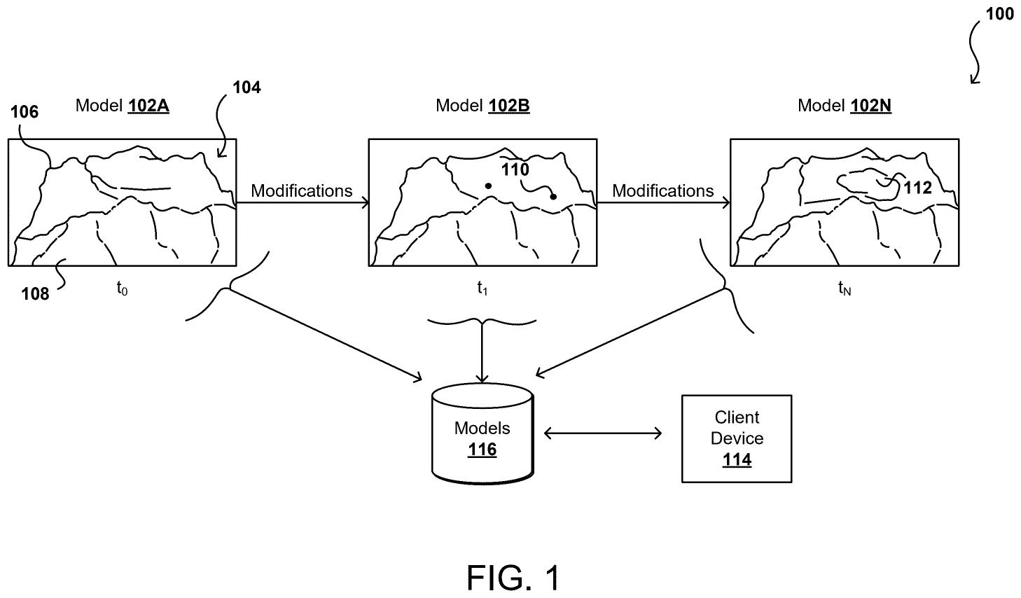

FIG. 1 illustrates an example environment 100 that can be used with embodiments of the present disclosure. In this example, a volumetric three-dimensional (3D) model 102 (e.g., model) is presented corresponding to one or more digital representations of a scene or object, which in this example includes a mountainous region and/or an outdoor area. The model 102 may be referred to as a digital twin. The model may be represented by a grid representation, such as by a number of voxels, as a 3D point cloud, or any other reasonable model representation that correlates one or more features of a space with attributes of that space. The model 102 may be used for rendering, mathematical operations, and/or the like. In this example, the model 102 shows a mountain 104 that includes ridges 106, slopes 108, and various other geometric features. Additionally, the different regions may also correspond to other attributes, such as material/composition, color, and/or the like. In at least one embodiment, the model 102 may be rendered by one or more rendering programs to permit a user to visualize and interact with the model 102, which may include zooming in for greater detail, rotating, panning, and other actions.

The representations shown in the model 102 may correspond to millions or billions of individual voxels, points, and/or the like, which may generally be referred to as nodes herein for clarity. The nodes may each include information associated with respective spatial positions, attributes, and other features. As models 102 represent larger areas or more complex regions, their size may become unwieldy, particularly for streaming applications or when trying to store and execute models locally. This problem may be exacerbated as models change over time. For example, the model 102A may represent the mountain 104 at time to and the model 102A may be modified as the model 102B at a later time t1. As shown, different regions of the mountain 104 have been removed in the model 102B and exploration bores 110 have been drilled in the representation of the model 102B. Further modifications and iterations may be performed over time, as shown in the model 102N at the time ty, where a clearing 112 is formed, which may represent an industrial operation, such as a mine. Storing each of the models 102A-102N is resource intensive. Furthermore, the entirety of the model may not be relevant for a given task or operation. For example, a user viewing a rendering of the model 102N may be most interested in the clearing 112 and not want to render or view other areas of the mountain 104. Systems and methods of the present disclosure may address and overcome these problems by selectively storing modifications to the models 102A-102N over time while reusing existing features that were not stored. As a result, updated versions may be smaller and easier to manage. Furthermore, in at least one embodiment, only relevant parts of a model may be “requested” or otherwise used by the application. For example, the entire model may be stored at some location, but only portions of the model responsive to a specific request may be provided and then subsequently rendered. In other words, the data-structure discussed herein may be used to selectively load and/or update only part of the model. As a result, fewer memory, network, and/or storage resources may be used compared to querying an entire model.

In at least one embodiment, a client device 114 may access the model(s) 102 from one or more model datastores 116, for example over one or more network connections. The model datastores 116 may be used to stream data to the client device 114 for rendering and/or mathematical operations, among other options, which may be performed locally on or visualized on the client device 114. As discussed, the models 102 may be very large files and it may not be feasible or practical to download or provide large volumetric models to the client device 114, for example, in areas where network coverage does not facilitate sufficient download speeds. Embodiments of the present disclosure may be used to stream volumetric model data to the client device 114 using one or more improved storage systems to permit smaller quantities of data to be distributed based, for example, on a desired level or detail or particular attribute of the model, as discussed herein. Additionally, various embodiments may also stream a 3D region of interest, rather than an entire 3D volumetric model. In this manner, systems and methods may permit an end user to select specific portions of the model (e.g., regions, levels, attributes, etc.) for streaming, thereby reducing consumption of resources.

Various embodiments of the present disclosure are directed toward an advanced variable precision streaming system for volumetric data. Systems and methods may be used across a variety of industries that use volumetric data for decision making and design, such as, as non-limiting examples, civil engineering or mining environments. In mining applications, as an example, operations may occur in difficult environments (e.g., underground mine sites, remote locations, etc.), which impose uncertainties such as low-quality data flow to/from the mine site due to network inconsistencies. Embodiments address and overcome these problems, among others, by providing a scalable digital twinning system that can effectively (1) render arbitrarily large models (e.g., terrains, buildings, tunnels, mines, planets) in their globality at various levels of details and (2) ensure the virtual models are modifiable as the physical object undergoes various changes. Furthermore, various embodiments may be optimized for running mathematical operations on arbitrarily large models by allowing efficient out-of-core processing to avoid running into random access memory (RAM) limitations. Additionally, the data-structure discussed herein may be used to selectively load only part of the model. For example, a specified region of the model may be loaded based on camera position for a rendering operation or based on a desired or selected material requirement when executing various Constructive Solid Geometry (CSG) operations.

Systems and methods of the present disclosure address and overcome problems with existing systems, such as block-based systems that use grid-aligned representations (e.g., voxels). Regular grids are limited in their representable topology, causing the models to compromise between storage, computation times, and accuracy. Moreover, regular grids do not allow for adaptive precision on areas with large variation of curvature, resulting in large storage usages and computation times. In contrast, embodiments of the present disclosure are adapted for use with non-grid-aligned blocks of arbitrary sizes, as well as unstructured point-clouds and other representations, resulting in significantly lower storage usage as well as lower network usage for streaming. Embodiments overcome shortcomings present in existing data structure and streaming voxel rendering approaches. For example, approaches that use shared octree data structures may not be suitable for arbitrary blocks and may be limited to adaptive regular grids, thereby reducing potential accuracy with the model. Similarly, storing volumes as a hierarchy of regular grids may limit sampling along grid lines. Furthermore, converting the models to meshes may not overcome the problems because mesh-based models may require complete model downloads for rendering or mathematical operations and/or may use complex, resource intensive solutions that may still be inadequate for various rendering or mathematical operations.

Systems and methods may be directed toward a database format for storing large-scale 3D models for streaming and CSG mathematics. The stored 3D models may be composed of a set of primitive shapes, such as axis-aligned cubes (e.g., block models) or points (e.g., point clouds). Additionally, systems and methods may also extend to a variety of other primitive geometry types, such as cylinders, meshes, etc. In at least one embodiment, each primitive is associated with a set of attribute values, which may be numeric or alphanumeric, as two non-limiting examples. The attributes may be defined by a user or may have default naming conventions. The stored models may be in the form of DAGs, where each root uniquely identifies one 3D model. As a result, a tree may span the DAG starting at the 3D model root and forming a hierarchical representation, with leaves containing the model primitive geometries and internal nodes containing bounding volumes of their children. In at least one embodiment, the trees associated with the database format may be arbitrary degree BVHs. In at least one example, a degree of 4 may be used, but it should be appreciated that more or fewer degrees may be used based on factors such as compute resources, user preferences, model types, and the like.

Embodiments may facilitate geometric operations and rendering by incorporating acceleration structures and different levels of detail (LoDs). For example, BVHs may facilitate geometric operations, such as identifying all the leaves intersecting some other geometric primitive or identifying all the leaves intersecting any leaf from another BVH. As a result, efficient CSG operations may be performed. Additionally, because each bounding volume of an internal node encloses the volume of all its descendants, it can be interpreted as a geometric approximation of its descendant, making it suitable as a coarse representation of the volume it bounds, to be rendered instead of all its leaves when they are far away from the point of view of a virtual camera. Furthermore, node attributes may be associated with each node and each node may be given multiple attributes. The nodes and the respective attributes may be stored in a table-like structure where attributes are distributed by columns and nodes are represented along rows. Leaves of the BVH may contain the user-defined attribute values whereas internal nodes may contain a value computed recursively as a combination of its children's values. A variety of different methods may be used to combine the values, such as averages, maximums, area-weights, and the like.

Efficient storage of the DAG for individual models enables the use and implementation of the system with arbitrarily large models. In at least one embodiment, input data files are not completely loaded into memory to construct a model. For example, input data sets may include information such as text file formats (e.g., comma separated values (CSV)), generated models, etc. that are separated or segmented by attribute. Additionally, the entire model may not need to fit into local memory for rendering or CSG operations. Systems and methods may implement the use of the individual attributes with one or more compatible rendering services to identify and download the needed attributes based on individual service coloring strategies. Additionally, various embodiments may also partition the BVH into multiple shards that cover different regions of 3D space, which may also reduce streaming bandwidth requirements. Furthermore, as discussed herein, embodiments may avoid data duplication, for example, due to a series of modifications to the model. At least one embodiment includes a shallow DAG of sharded linear BVHs. A multi-version concurrency control (MVCC) may be used to create new objects without destroying old objects. For example, as a model is modified or changed, a new version may be generated while maintaining one or more older models. In at least one embodiment, database objects may be read-only and tied to some globally unique ID, which reduces the complexity of caching. Furthermore, models may not be mutated directly, and instead, embodiments may either link data from a source model unmodified or clone a subset of the source data to be re-imported.

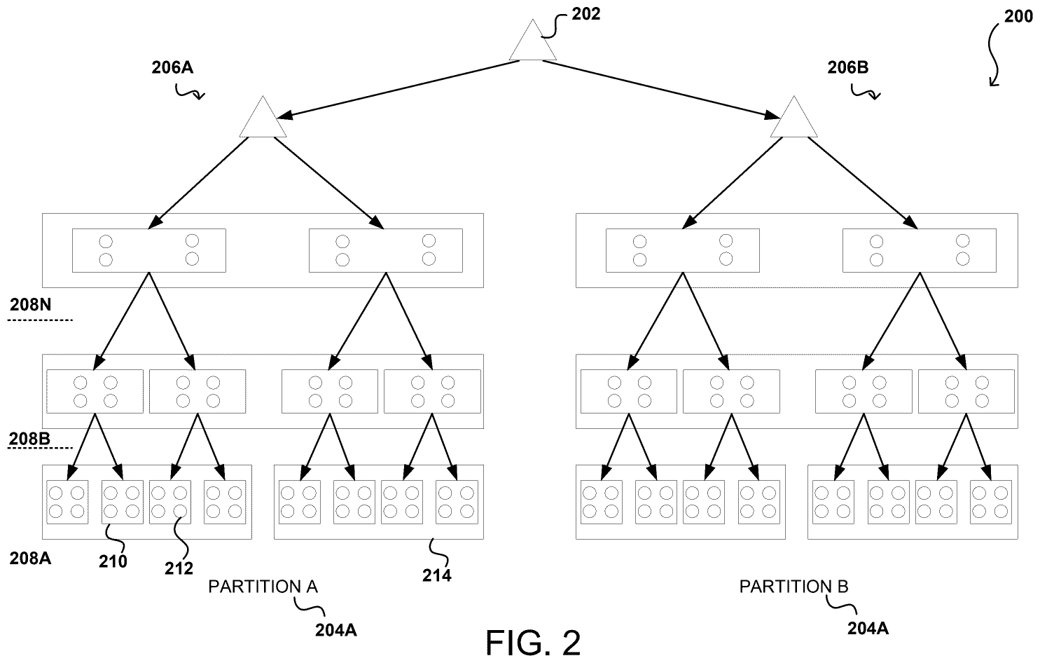

FIG. 2 illustrates a schematic representation 200 of the DAG structure that may be used with embodiments of the present disclosure. In this example, a single model is distributed over many database objects. A root 202 of the model may be referred to as a model file and tracks the tabular schema of geometry and attributes, as well as a run-length encoded set of chunks to be included from each data partition 204A, 204B. In at least one embodiment, a partition may refer to a single densely packed linear BVH that is distributed into many fixed-size column shard files. Each shard spans only a single column at a single LoD, and each LoD can contain many shards. Because of the linear layout of the BVH, it is possible to traverse the BVH without explicit child pointers. Child node addresses may be a fixed linear function of the parent node address.

In at least one embodiment, each partition 204A, 204B also has a chunk BVH file, which stores a linear BVH of chunk axis-aligned bounding boxes (AABBs). The configuration may be used as a coarse-grained acceleration structure which allows client workloads to fetch only the shards of data that are strictly necessary and/or desired for a geometric query. For example, the chunk BVH may be used to initialize a tree data structure that a renderer uses for streaming chunks of data into a GPU.

As discussed herein, the linear BVH assigns to each leaf an AABB along with an integer address from 0 to N, for N total leaves. The leaves are permuted to form a binary spatial partition (BSP) of the AABB centroids. From there, the BVH may be constructed bottom-up by grouping together N leaves at a time and finding a parent AABB that contains them all. The process may continue through the tree until there is a single root AABB. In one embodiment, the number of leaves is 4. However, N could be a different number and may be particularly selected based on one or more factors of the model. For example, N could be equal to any branching factor B that achieves a desired tree height.

In this example, the root 202 may be a small file that can be easily stored and managed within the database. The root 202 is shown as being portioned across the partitions 204A, 204B, which are represented by two subtrees 206A, 206B. As will be discussed herein, information may be shared and stored across models. Various LoDs 208A-208N are illustrated in this example as the hierarchical structure of the subtrees 206A, 206N. In this example, as illustrated by the data chunks 210, the LoD 208A is the lowest level (e.g., LoD 0) and provides the greatest amount of detail, and in contrast, the LoD 208N is the highest level and provides a lesser amount of detail. For example, in an example associated with a mountain top having trees, at the LoD 208A, individual trees and their branches may be viewable and at the LoD 208N only a canopy of leaves may be seen. In other words, the chunks 210 may be down sampled at higher LoDs.

In at least one embodiment, the BVH may be configured to be distributed as many small shards, which may be approximately 1 MB in size. Splitting planes for the small shards may be selected at multiples of an integer power of B based on a desired shard size. In at least one embodiment, B may refer to a defined branching factor for the BVH tree, as noted herein. B may be a tunable or configurable parameter and may be adjusted based on various characteristics of the model. One or more example embodiments may set B as equal to 4, but these examples are provided by way of non-limiting example. As a result, each shard may correspond to a particular spatial partition of the entire BVH (e.g., a shard may correspond to exactly one spatial partition). In at least one embodiment, splitting planes are determined using one or more operations, such as a recursive quantile calculation and pivoting algorithm, as one non-limiting example.

The use of the BVH structure of the present disclosure may reduce or eliminate storage of child pointers. Instead, the child addresses may be implied by the parent addresses, as shown in Equations (1) and (2) below:

$$child address = parent address * B + child offset \qquad ( 1 )$$

$$parent address = floor ( \frac{child address}{B} ) \qquad ( 2 )$$

Systems and methods may also be able to address and overcome direct mutation concerns with linear BVHs. For example, while it may be computationally easier to rebuild the BVH from scratch than mutating it, embodiments may implement copy-on-write techniques with tree structures to create new models out of old ones.

Attributes may be downsampled after BVH construction. In at least one embodiment, down sampling starts from the leaf attribute values, which have been permuted identically to the leaf AABBs. Downsampling provides attribute values suitable for rendering with LoDs, similar to an image pyramid. As discussed, different LoDs may be associated with different attributes, because some may not be visible at different LoDs, thereby providing for more efficient rendering and/or computational operations.

Individual chunks 210 may include nodes 212 and a number of chunks 210 may be further associated with shard files 214. The degree of the tree 200, number of nodes 212 per chunk 210, and number of chunks 210 per shard file 214 may be particularly selected for instance of the database. One non-limiting example includes 1024 nodes per chunk, 1024 chunks per file, and a tree of degree 4.

Each level of the BVH may be grouped into the shards 214 and then the shards 214 may be serialized before writing a compressed binary object to durable storage with a descriptive deterministic key. Systems and methods may use a variety of different compression techniques. As one non-limiting example, LZ4 compression may be selected due to its compression ratio with fast decompression throughput. Other methods, such as ZSTD and the like, may also be used. In at least one embodiment, the entire partition may be labeled by a 128-bit universal unique identifier (UUID) generated by the host that constructed the partition. A partition globally unique identifier (GUID) may be stored in model files that reference the partition. Accordingly, systems and methods may be used to store a smaller (in bytes) and coarser linear BVH derived from the upper levels of the complete linear BVH. As will be discussed herein, in at least one embodiment, a single partition is constructed entirely in volatile memory and external partitioning may be implemented to import model data that does not fit within memory.

Various embodiments may implement hierarchical coordinates by using the tree structures described herein. As a result, systems and methods may cut the size (in bytes) of uncompressed geometry shards in half while still supporting expected data types, such as double-precision floating point coordinates (e.g., 64 bits per scalar). Because the extents of the partitions are known, the partition centroid may be subtracted from any coordinates in that partition and be assured that the results will not exceed the half extents of the partition. By limiting the extents of the partitions, casting from double precision to single precision floats is permitted by translating them back into “global” coordinates using the partition centroid.

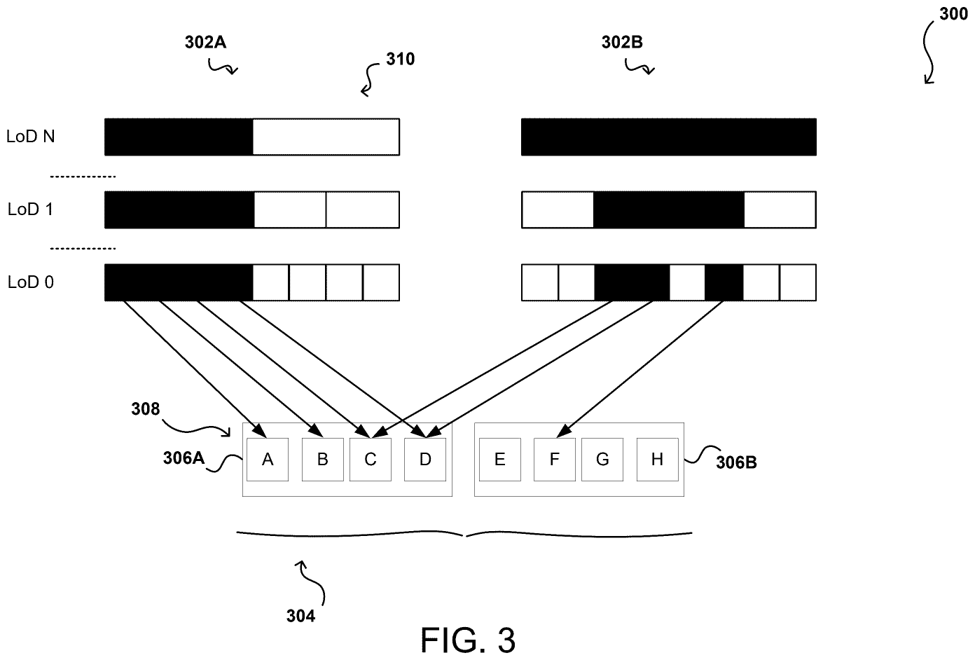

As discussed herein, in at least one embodiment, models may share partitions or at least portions thereof. FIG. 3 illustrates a schematic representation 300 of two models 302A, 302B sharing a partition 304. It should be appreciated that the models 302A, 302B may share multiple partitions and that the illustration of a single shared partition 304 is by way of non-limiting example for illustrative purposes and clarity. The illustrated partition 304 includes 2 shards 306A, 306B and 8 chunks 308 (e.g., A-H), with 4 chunks (A-D) on the shard 306A and 4 chunks (E-H) on the shard 306B. In this embodiment, the chunks 308 may have different numbers of individual nodes, for example, based on the LoD. The chunks 308 are characterized by letter for case of explanation.

In this example, each model 302A, 302B has a hierarchical bitset for each partition referenced, and each bit of the various LoDs correspond to one leaf chunk. A set bit acts as an implicit pointer to link in the chunk at that offset. When the models are serialized, the bitsets may be compressed into run-length encoded arrays of ranges, where only the ranges at LoD 0 are stored because higher LoDs can be derived by down sampling LoD 0 using the logical OR function. As shown in this example, at LoDs 1 and 2, a bit is set if any of its descendants are set.

The example of FIG. 3 includes the bits 310 at respective LoDs. At LoD 0 for the first model 302A, the bits 310 correspond to the chunks 308 labeled as A-D. However, at LoD 0 for the second model 302B, the bits 310 correspond to the chunks 308 labeled as C, D, and F. As shown, different chunks 308 may be used across the different shards 306A, 306B and also may be shared between the two models 302A, 302B.

Systems and methods discussed herein therefore address and overcome problems with existing approaches for storage and rendering of large volume models. Present embodiments enable scaling for large (e.g., millions or billions) of nodes for a given volume that would otherwise not be feasible with other storage techniques, such as using a single QBVH (e.g., a BVH where each node has up to 4 children). For example, scaling may be inefficient with the QBVH because model-sharing, which is enabled by the present disclosure, could result in arbitrarily deep and/or degenerate trees. Furthermore, the presence of explicit pointers between nodes of the QBVH increases storage requirements by an order of magnitude. Systems and methods also overcome problems with rendering based on cube instances. Embodiments of the present disclosure provide a data structure that may be used with a variety of different model types (e.g., blocks, point clouds, meshes, etc.) and enable efficient out-of-core CSG operations between virtually unbounded models without RAM limitations. In at least one embodiment, CSG operations between unrotated models may retain full precision between models because of the lack of specific grid alignment. Furthermore, providing LoD with the structure enables streaming for pixel-accurate rendering of large models, even when using mid-range rendering hardware. Systems and methods may be used with generating digital twins, as one example, to represent very large volumetric models and their evolution over time while preserving immediate access to intermediate versions of the models, all while maintaining a low amount of duplicated data.

In at least one embodiment, each partition BVH is constructed entirely in volatile memory. Volatile memory locations may be insufficient to store entire models, and as a result, to import a model that does not fit in memory, systems and methods may create a coarse-grained partition of the data using the file system for scratch space, which may be referred to as external partitioning or out-of-core partitioning.

External partitioning may include identifying a set of splitting planes that partition the entire data set. For example, a one-dimensional quantile function of the data set may be estimated in bounded memory with a t-digest data structure. To avoid scanning the entire data set twice (e.g., once for t-digest and the again for sorting the data into partitions), the t-digest may be calculated using only a random sample of the data set. In various embodiments, a t-digest is constructed for each spatial axis. From the t-digests, a spatial axis (X, Y, or Z) with highest variance is selected and splitting planes are placed at multiple quantiles in order to make each partition approximately the same size. Maintaining this structure may provide a probabilistic guarantee on the maximum size of a partition, which helps to load multiple partitions into memory without overrunning the memory budget. In addition, or alternatively, variability in partition sizes, may be addressed to avoid using too much memory by limiting the current total size resident in memory using a semaphore. Once the coarse splitting planes are determined, data is streamed from the source file and each leaf is placed in one partition using a binary search over the splitting planes. Each partition may be written as a set of flat files.

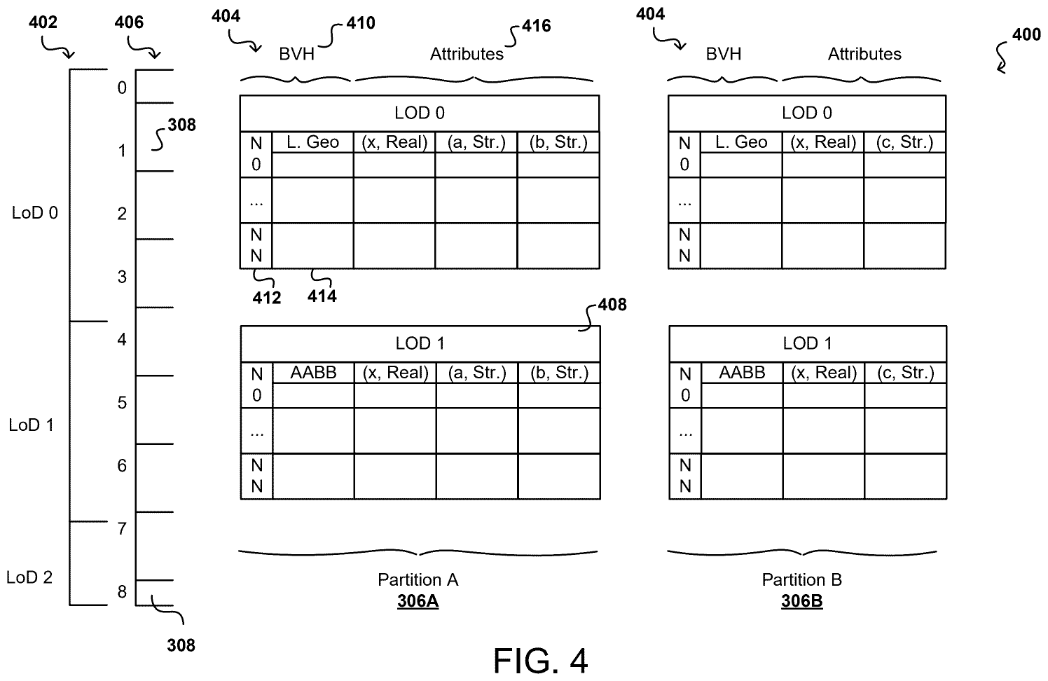

FIG. 4 illustrates a representation 400 of a geometry file and related attribute files that may be used with embodiments of the present disclosure. The illustrated geometry file is representative of a BVH subtree containing N attributes. As discussed herein, individual attributes for each node at different LoDs may be stored to enable attribute-level selection for rendering, mathematical operations, and or the like.

In this example, an LoD index 402 includes different LoDs aligned with individual files 404 within the partitions 306A, 306B. For example, as discussed herein, different models may share partitions and/or files for a given model may be distributed over various partitions. A chunk identification index 406 is also illustrated as an example to illustrate which chunks 308 correspond to different LoDs. As a non-limiting example, the illustrated indexes 402, 406 show that the chunks 308 corresponding to chunks 0-3 are associated with LoD 0, the chunks 308 corresponding to the chunks 4-7 are associated with LoD 1, and the chunk 308 corresponding to chunk 8 is associated with LoD 2.

The individual geometry files 404 are shown as a table representation that includes columns and rows, but such a configuration is provided for clarity and by way of non-limiting example. A header 408 illustrates the associated LoD. A BVH 410 may correspond to the first two columns, indicative of a node column 412 and a geometry column 414. Additional columns in this example correspond to attributes 416. For example, attributes can include a variety of values positioned within the geometry file 404, including numeric and alphanumeric values (e.g., real numbers, floats, strings, etc.). In at least one embodiment, where the columns correspond to a string, the attribute file may contain a string identification (ID), instead of storing the complete string. The string IDs may identify the string values on a per-partition string table to avoid storing duplicate string values.

In operation, if that BVH subtree contains N attributes, there will be N attribute files. For example, a first file may correspond to the node column 412 and the x value (e.g., the third column), a second file may correspond to the node column 412 and the a value (e.g., the fourth column), and so forth. As a result, if a user wanted to render or perform operations based on a particular attribute, only the associated attribute may be provided, rather than providing the entire table or the entire volume, thereby enabling more efficient storage and streaming. In at least one embodiment, attributes are further stored by LoD. As an example with respect to the x value (e.g., the third column), there may be a first attribute value for the LoD 0, a second attribute file for the LoD 1, and so forth. Accordingly, the representations may be further segmented to provide more efficient delivery for various end user operations.

As illustrated herein, a model may be fully-specified by several types of binary objects, including a model file, a chunk BVH file, a geometry shard file, and an attribute shard file, among other options. The model file 404 may be a relatively small (usually measured in KB) “root” of a BVH that spans many shards and the model may track a set of partitions. In at least one embodiment, the model may only reference a set of subtrees associated with each partition, which as discussed herein, may be associated with storage of leaf addresses as ranges. Accordingly, the storage structure of the present disclosure allows many models to reference a single partition. In other words the shallow DAG of the present disclosure overcomes problems with existing model structures that may not directly reference other models and/or self-contained partitions. The configuration of the shallow DAG limits a number of indirections required to reach a piece of data, thereby providing more efficient data streaming. The constraints imposed on the shallow DAG discussed herein may also reduce or eliminate the use of packfiles.

During model traversal, different reference partitions are traversed, with each partition having a corresponding chunk BVH file (e.g., a linear BVH where each node represents a chunk). With rendering applications, the use of chunks may be preferred over shards because the chunks are smaller, and therefore, can be uploaded to GPUs more quickly. A shard is one file/object consisting of many shards. In certain embodiments, and almost all shards and chunks are the same size. However, that may not be the case in all configurations. For example, shards and chunks may be different sizes when partitions are not evenly divisible. The chunk BVH file is useful to filter out large sections of a partition by intersection with a query volume. Once it is known which shards are needed from each partition, those particular shards can be fetched from either a local cache or storage location. Systems and methods of the present disclosure enable both CSG and rendering workloads to fetch only the subset of data chunks that are relevant to a given query. In the case of rendering, a virtual camera of the model may create a frustum that intersects a coarse “summary” BVH of the data chunks, and those chunks are prioritized for streaming at whatever LoD is required for near-pixel accuracy from the renderer. Additionally, requests for occluded chunks may be culled using a hierarchical depth buffer. As a result, smaller quantities of data may be streamed while still providing the desired attributes and detail requested by the user.

Various embodiments maintain a local cache both on the file system and in volatile memory. When a user requests a shard, both the memory cache and the file system cache are checked. If the data is not found, then the data may be requested from a storage location and placed directly into the memory cache. The user may also spawn an asynchronous task to persist the shard into the file system cache so that repeated network requests are not used when the shard is evicted from the memory cache.

Embodiments may include different memory caches for different operations, such as for a renderer and for CSG, among other options. These caches may have different parameters, such as different eviction policies. For example, the renderer may want to keep a specific cross section of the model in memory as determined by the virtual current camera view. As another example, the CSG cache may want to retain recently used shards. While these caches do not communicate, they may both share the local file cache. Embodiments may also coalesce requests for the same data (originating from the same process) before reaching the file cache or network layer.

The file cache(s) may maintain a bounded size by doing periodic garbage collection. For example, one or more algorithms may be implemented to walk the cache directory, create a list of entries and sorting them by the “last accessed” timestamp, and then the oldest entries until the total size of the directory is less than some bound. It should be appreciated that other methods may be used for deleting files from the cache.

Embodiments of the present disclosure may be used with immutable objects, and as a result, caching algorithms may be simplified with no or substantially no cache invalidation. As discussed herein, using clone-on-write semantics for creating new models from old ones may provide such benefits. Additionally, implementing clone-on-write enables the use of content delivery networks (CDNs) to cache model data close to client networks.

Systems and methods may also be used to address configurations associated with model deletion where data is shared between models. In operation, when a model is deleted, the set of shares that are to become orphaned are identified. For example, a linear scan model may be used to construct a set of linked partitions between models, and any of the partitions from the deleted model not in the linked set are considered orphaned. Orphaned partitions may then be deleted. For the implementation where CSG operations are used, it may be the case that a CSG batch will create intermediate models that do not need to be retained. In this case, new shards created by different CSG batches are tracked, and any of the shards that are not linked by a final model are deleted.

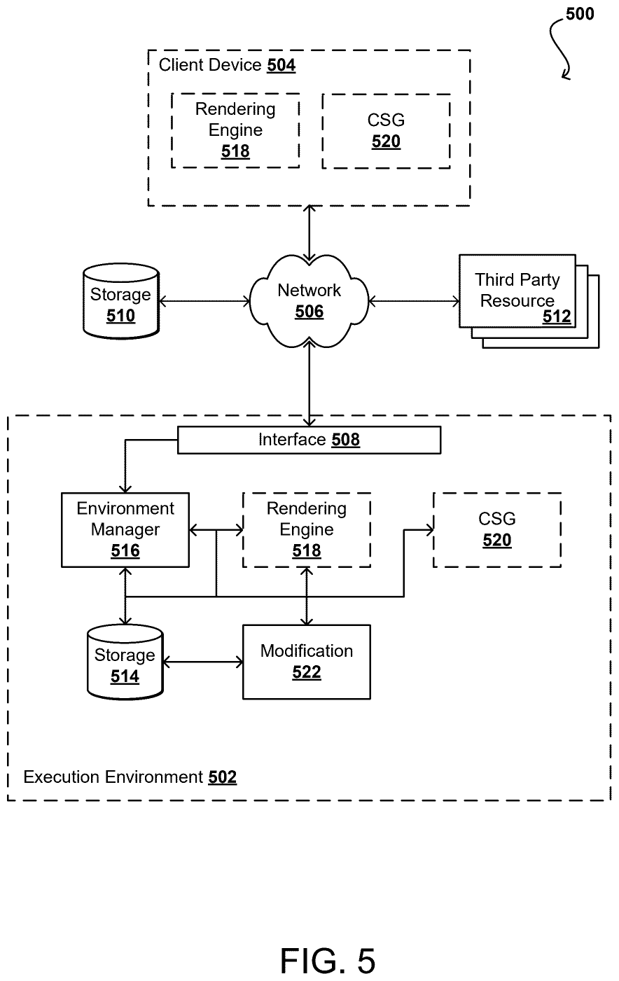

FIG. 5 illustrates an example system 500 for volumetric model storage, delivery, and computation, in accordance with various embodiments of the present disclosure. Various embodiments of the system 500 may be used for storing large volumetric models (e.g., block models, point clouds, meshes, etc.) as well as making such large volumetric models available for rendering and CSG workloads. As discussed herein, a volumetric model may correspond to a 3D volume. In embodiments where the model is a block model, the block model may contain billions of blocks, each of which specifies a 3D centroid, 3D extents, and N number of scalar or string attribute columns. The system may 500 may receive, as an input, one or more configuration files, which may be in the form of CSV files, as one non-limiting example. These files may occupy considerable storage volumes depending on their size, complexity, and the like. As an example, a single uncompressed model may exceed 400 GB. It may be undesirable or infeasible for a user of the system 500 to download an entire model each time they wish to view it and loading the entire model in host device memory may not be realistic or may cause other problems, such as increased costs to upgrade compute devices. In operation, users expect to have models stored in a cloud object storage provider to offload storage requirements from user devices and to increase availability of models across a number of users operating in different locations. Furthermore, cloud storage may also increase security of the models and facilitate version control and other operations. By storing the models in the cloud, the user may wish to stream data on-demand when the model is used. However, due to bandwidth considerations or network availability, users may wish to stream data in relatively small chunks that match the desired fidelity and accommodate bandwidth constraints.

In this example, an execution environment 502 may be used to receive one or more models, store the one or more models, and provide the one or more models for streaming and execution of various computational tasks. It should be appreciated that various other components may also be included, or hosted separately in a different environment, and are not shown for clarity with the following discussion. Furthermore, these components are shown by way of example and are not intended to limit the scope of the present disclosure. A client device 504 (e.g., a client, a user, an end-user, an authorized user, a customer, etc.) may provide one or more requests or instructions to the execution environment 502 via one or more networks 506. The client device 504 and/or the client/user may be referred to interchangeably in that the client device facilitates the interaction with the resource provider environment 502. Moreover, the client device may execute one or more actions or tasks according to one or more rules or instructions stored on different memories without physical interaction or explicit instructions from a user. For example, the client device may correspond to a computing device programmed to send a signal to execute one or more workflows responsive to receiving an input that may be automated, such as a workflow to execute one or more operations on a portion of a model. The client device 504 can include any appropriate electronic device operable to send and receive requests, messages, or other such information over an appropriate network 506. Non-limiting examples of client devices 504 include personal computers, tablet computers, smart phones, notebook computers, various edge devices, and the like. The one or more networks 506 can include any appropriate network, including an intranet, the Internet, a cellular network, a local area network (LAN), or any other such network or combination, and communication over the network can be enabled via wired and/or wireless connections.

In this example, the execution environment 502 may be associated with or include one or more underlying resources, such as compute resources, storage resources, and/or the like. These resources can include physical and virtual resources that may be located at one or more locations controlled by a provider of the execution environment 502 or a third-party, or may be located at a location controlled by the user, or an entity with which the user is associated. As discussed, different resources may be omitted for clarity or may be shown as groups of blocks or components.

Various embodiments may be used with distributed computing environments, also referred to as a cloud provider network or “cloud.” The cloud may refer to a pool of network-accessible computing resources (such as compute, storage, and networking resources, applications, and services). In at least one embodiment, the cloud enables on-demand access and specific user configurations for various resources. These resources can be dynamically provisioned and reconfigured to adjust to variable load. Cloud computing can thus be considered as both the applications delivered as services over a publicly accessible network (e.g., the Internet, a cellular communication network) and the hardware and software in cloud provider data centers that provide those services. As discussed, the cloud environment may implement a variety of different computing resources or services, including virtual compute services, data processing services, data storage services, and/or the like.

The execution environment 502 may include an interface layer 508 to receive requests from the client device 504 and/or other resources and/or to facilitate communication back to the client device 504. The interface layer 508 can include components such as interfaces (e.g., application programming interfaces (APIs)), load balancers, request and/or data routers, and the like. The interface 508 may also be used to interact with one or more storage services 510 and/or third party resources 512. Additionally, in at least one embodiment, the execution environment 502 may include its own storage services 514 (e.g., datastores, network attached storage, etc.). For example, the client device 504 may provide one or more models and/or provide access to the one or more storage services 510 that are either imported into the storage service 514 and/or are streamed or otherwise selectively accessible from the one or more storage services 510. In operation, the user device 504 may stream data from the execution environment 502 that is cached in the device file system and volatile memory.

In at least one embodiment, an execution manager 516 may be used to direct and/or coordinate operations within the execution environment 502. For example, the execution manager 516 may receive various requests and/or files from the client device 504 and/or other services (e.g., the storage service 510, the third party resources 512, etc.) and direct different calls or workflows to different environment operations. For example, the execution environment 502 may implement one or more storage operations using a rendering engine 518. The rendering engine 518 may be used to generate one or more tree-structure storage arrangements, as discussed herein, that may be used to facilitate streaming and workload execution on smaller files. Furthermore, the storage arrangements may also provide improved access to individual attribute-based controls and further implement version management to track changes to different models over time.

Various operations may be performed using the execution environment 502, with this example including both a rendering engine 518 and a CSG operations engine 520. It should be appreciated that one or both of the rendering engine 518 and/or the CSG operations engine 520 may execute within the execution environment 502 or locally on the client device 504. For example, the rendering engine 518 and/or CSG operations engine 520 may be provided as a downloadable for location execution. In various embodiments, some or all of the processing may be performed at the execution environment 502 and then results and/or output may be provided to the client device 504. The rendering engine 518 may be used to visualize one or more 3D volumetric models and/or portions thereof, for example, using one or more processing components, such as a local device GPU, and/or the like. In at least one embodiment, the rendering engine 518 may be particularly selected to efficiently handle billions of blocks by dynamically culling and selecting a precise LoD perceivable by the user. In at least one embodiment, the rendering engine may intelligently traverse the model every frame and stream only what is needed from RAM, disk, and the cloud. Additionally, the rendering engine 518 may include a fully GPU-driven and hierarchical culling pipeline to execute arbitrary culling logic efficiently.

Embodiments of the present disclosure, as discussed herein, may provide further improvements to rendering operations due to the optimized storage format discussed herein that may be GPU-friendly to enable efficient streaming of LoDs to the GPU due to the splitting into pages sized to optimize the GPU memory bandwidth utilization. Because of the conservative nature of the BVH bounding volumes, frustum and occlusion culling, among various other methods of culling, may be executed efficiently by the GPU. In at least one embodiment, the rendering engine 518 may be used to color objects based on attributes stored in the database. Attributes attached to LoDs may be automatically derived by downsampling attributes at the leaf of the hierarchy. Moreover, attributes expression can be applied to alter the rendered values, or to hide some geometries, on-the-fly based on business logic.

Real-time graphics pipelines typically render images by rasterizing a stream of triangles onto a framebuffer. This technique requires no complicated acceleration structures and was widely implemented in modern graphics hardware. While these techniques may be applied to large-scale block model datasets by utilizing instanced rendering to reduces overhead caused by inefficiencies in command buffer recording, mesh generation, and primitive assembly, instanced rendering does not change the time complexity of rasterization which scales linearly to the number of primitives due to the volumetric nature of various datasets. Various rendering engines 518 that may be implemented within the execution environment 502 may have a rendering time complexity that scales with the screen resolution instead of the geometric count. Such a rendering engine may render highly complex scenes with near-constant frame rates. In at least one embodiment, the scene complexity may be bounded by the amount of video memory available on the host system. The rendering engine 518 may further enable the real-time rendering of highly complicated scenes using state-of-the-art techniques such as virtualized geometry, out-of-core streaming, GPU-driven rendering and two-pass hierarchical Z-buffer culling.

In at least one embodiment, the rendering engine 518 may populate a queue with the root nodes for each partition of each instance of the models. By utilizing a persistent thread compute shader, BVHs are traversed from the root in parallel on the GPU. As nodes are traversed, one or more culling operations are used to remove nodes that are not visible. When either a leaf node is hit, or a node is small enough that rendering its children would not significantly increase visual detail, the node is output to a buffer for rasterization.

As discussed, during traversal, hierarchical culling can be performed on all tree nodes. Traversal starts from the root node, implying that larger nodes will be processed first. Accordingly, culling can efficiently be performed on entire branches of the tree early during the traversal at a larger granularity, saving exponentially more work later on. The rendering engine 518 may spend a minimal amount of time on nodes that will get culled. Various culling techniques and methods may be used, including but not limited to frustum culling, occlusion culling, exclusion bitmask culling, clipping plane culling, and LoD culling, among others.

In at least one embodiment, the rendering engine 518 may implement persistent queues to traverse hierarchies in parallel on the GPU. Persistent queues may use a fixed amount of workgroups that are executed on the GPU and switch between states of waiting for data to be written, processing data, and writing out data. The queue buffer may be a fixed-size buffer that stores all or substantially all of the nodes to be processed during a single pass of the compute shader. Workgroups may then use atomic integers to claim fixed-size ranges within the queue buffer and loop until nodes are written into the specified memory range for processing. Once all nodes have been written and processed within the specified range, the workgroup will claim another range. When processing node batches, workgroups may then use another atomic integer to claim a slot to write any nodes to the queue that need further processing. Another fixed-size buffer and atomic integer may be used to write out the AABBs to be rendered following that pass.

Persistent queues may rely on a forward-progress guarantee, which is an implicit behavior present on some GPUs, but may be missing from others. The forward-progress guarantee specifies that while some threads are waiting for data to be written, other threads will eventually be scheduled for execution by the GPU. However, if the GPU always schedules the same workgroup for execution without allowing other workgroups to run, the workgroup can be permanently starved of data.

In at least one embodiment, the hierarchical traverser may output a list of AABBs for rasterization, alongside a structure specifying the indirect draw parameters for GPU rasterization. The vertex count of the indirect draw call may be set to a constant. For example, a constant may be 18, to correspond to a number of vertices for three faces of a cuboid consisting of six triangles. With back-face culling disabled, only 3 faces of a cuboid need to be rasterized at any given point. The instance count of the indirect draw call indicates the number of AABBs pushed for rendering. In the rasterization pipeline, the vertex shader fetches the AABB using the instance index. It then transforms the three faces based on the AABB min/max coordinates and sends them for rasterization. Embodiments of the rendering engine 518 may use a forward rendering pipeline, so colors are directly drawn to the frame buffer. The BVH streamed to the GPU memory may be partially resident. During BVH traversal, the compute shader may discover nodes that have not been streamed in yet. In those cases, the rendering engine 518 renders the parent instead, which may provide a visually less jarring appearance compared to not rendering anything. In at least one embodiment, there may be different situations where streaming readback may be implemented. In a first, a node has been streamed in, and it is being used in some way, cither as a leaf or as a parent. As a result, the node is marked as “used” so the GPU knows not to evict it. In a second, the node has not been streamed in, but also has not been culled during BVH traversal. As a result, these nodes are marked so the CPU knows to stream them in, enabling rendering of the nodes contained within the BVH leaf.

A node is marked for readback by pushing to a readback buffer using an atomic counter. The readback request contains enough information for the CPU to locate the partitions needed to be uploaded to the GPU. Upon receiving the readback requests, the CPU evicts the least recently used (LRU) chunks and streams in more detailed data as indicated by the traverser. Per-leaf attribute data are streamed in as well.

As discussed herein, attribute-level rendering and operations may be executed using embodiments of the present disclosure. Attributes may be data associated with each leaf-level AABB. At any given time, the rendering engine 518 may pick one type of attribute and adjust the output color based on the attribute values. Attributes may be stored in storage buffers and are streamed in alongside geometric data. Various attributes that may be used and supported by the rendering engine 518 include, as non-limiting examples, RGB attributes, scalar attributes, and string attributes. Embodiments may also enable multiple pre-loaded attribute columns to be resident on the GPU at the same time. Accordingly, users may quickly switch between multiple attributes at runtime by removing the need to re-stream attribute data into the GPU when switching.

The CSG operations engine 520 may be used to execute one or more mathematical operations on the volumetric model or portions thereof. As discussed herein, the data structures provided by the present disclosure may be particularly suited and compatible with efficient CSG operations. For example, because each partition is given a pre-computed BVH data-structure covering all of its leaf chunks, it may be computationally efficient to construct, on-the-fly, a single BVH covering the whole model. Accordingly, a fast tree traversal is permitted (e.g., for intersection with a mesh, as well as fast traversal of a Bounding Volume Test Trec (BVTT), for intersections between two block-models (or a block-model and a point-cloud), etc.). Furthermore, because embodiments of the data-structure further provide shared partitions between models, or shared subsets of chunks within partitions, the CSG operation can operate in a local fashion. For example, a CSG operation affecting a small part of a model (e.g., by replacing one piece of furniture from a building model) will only have to download shards from partitions containing the furniture, instead of fetching the whole building. As a result, systems and methods permit efficient localized incremental editions on arbitrarily large models. This may be extended to a variety of applications such as mining, civil engineering, and/or the like. As non-limiting examples, geometric operations may include intersection, union, and merge, between two block-models; subtraction between two block-models, or between a point-cloud and a block-model; cutting a block-model with a mesh, or with any implicitly defined shape; and filtering-out parts of a model based on attributes-based predicates.

A modification engine 522 may also be included with embodiments of the present disclosure to track changes to various models, identify differences between various models, and maintain version control between models, as discussed herein. Accordingly, as the rendering engine is updated and/or CSG operations are performed, the modification engine 522 may generate various graphs or relationships between different model versions of time and implement the storage of new models that may, as discussed herein, reference chunks or partitions associated with older models.

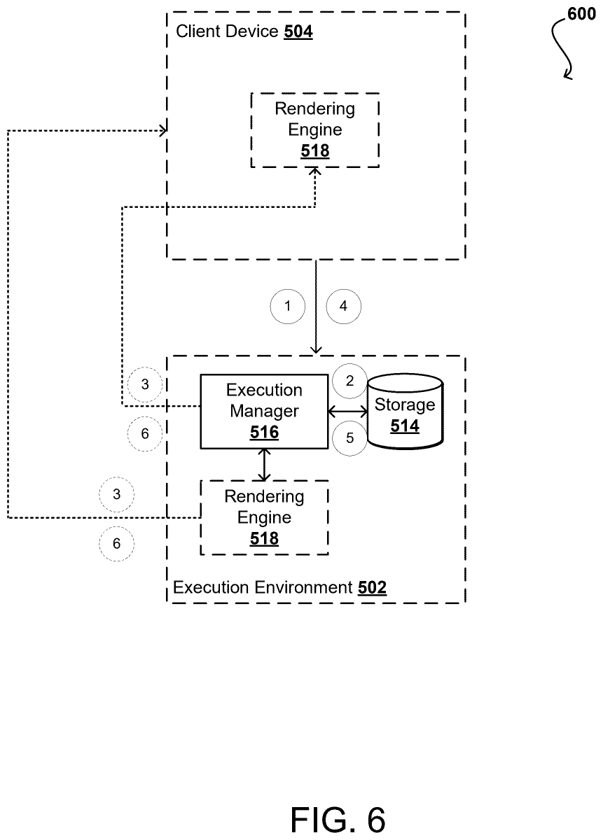

FIG. 6 illustrates an example environment 600 that may be used with embodiments of the present disclosure. In this example, the client device 504 transmits a request to the execution environment 502, for example to the execution manager 516, as illustrated by the numeral 1. The request may be to view a model based on a first set of configuration information, such as on an attribute-basis, as discussed herein. The execution manager 516 may query the storage system 514, as illustrated by the numeral 2, and pull one or more shards or chunks associated with the request. In at least one embodiment, as discussed herein, the storage system 514 may include one or more models, but various portions of the model may be culled for rendering by the rendering engine 518 as not being relevant or visible for a given virtual camera via. The rendering engine 518 may then be used to provide rendering information, as illustrated by the numeral 3, to the client device 504 to view the requested model.

The client device 504 may submit a second request, as illustrated by the numeral 4, that may be associated with an update to the original request. For example, the client device 504 may change the attribute associated with viewing the model. The execution manager 516 may then query the storage system 514 to retrieve the particular table associated with the attribute at the requested LoD, as illustrated by the numeral 5. In at least one embodiment, the rendering engine 518 may cull one or more nodes not associated with the virtual camera view and then provide the updated rendering information, as illustrated by the numeral 6. Accordingly, the client device 504 may stream large volumetric data models for particularly selected nodes and/or attributes.

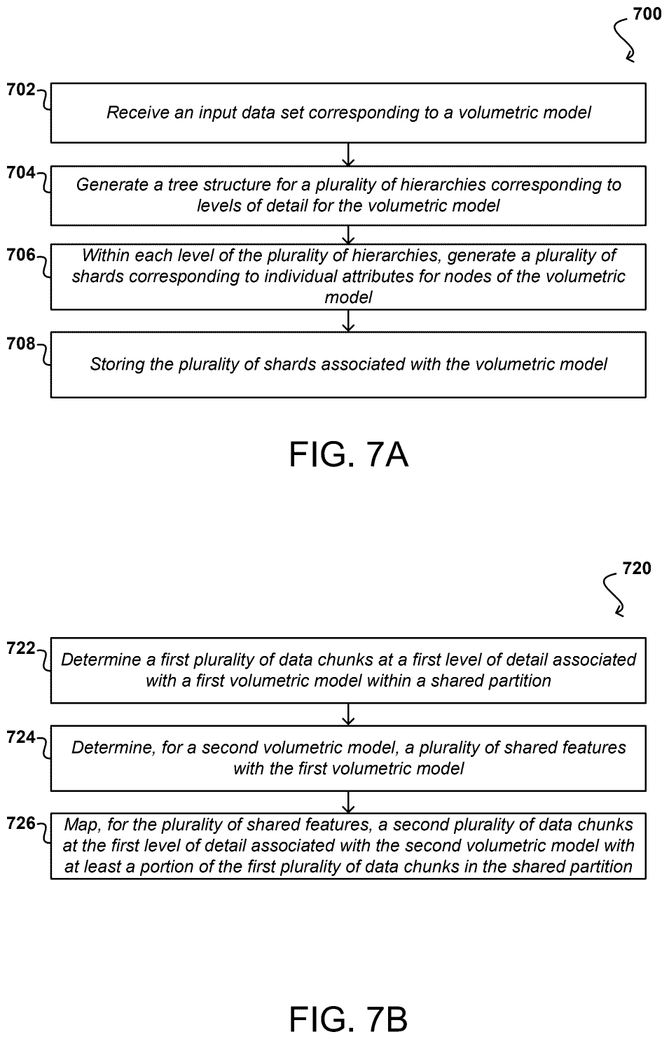

FIG. 7A illustrates an example process 700 that can be performed to store a volumetric model, in accordance with at least one embodiment. It should be understood that for this and other processes presented herein that there may be additional, fewer, or alternative operations performed or similar or alternative orders, or at least partially in parallel, within the scope of the various embodiments unless otherwise specifically stated. In this example, an input dataset corresponding to a volumetric model is received 702. The input data set may be provided in a variety of file formats, such as CSV, or any be a mesh model that is converted or otherwise modified.

In at least one embodiment, a tree structure including a plurality of hierarchies is generated 704. The hierarchies may correspond to different LoDs within the model, where a parent at a higher level contains the associated lower level leaves. As discussed herein, the LoDs may be represented by a linear BVH that assigns each leaf an AABB and an integer address. The levels of the hierarchies may correspond to a variety of chunks stored within shards. Moreover, each of the shards may be associated with attributes of the respective nodes within the chunks stored in the shards. For example, in at least one embodiment, a single attribute file will contain the attribute values for multiple nodes part of the same LoD. Accordingly, in at least one embodiment, within each level of the plurality of hierarchies, a plurality of shards may be generated corresponding to individual attributes for nodes of the volumetric model 706. The plurality of shards may then be stored 708. During operations, particular shards for particular operations may be identified and retrieved, and as a result, the entire model may not need to be provided or used for execution of various operations, such as rendering or CSG. For example, only a portion of the model (e.g., a requested spatial locality) of the model may be provided and used for rendering or CSG. However, in at least one embodiment, the entire model could also be provided.

FIG. 7B illustrates an example process 720 that can be performed to map shared features between models, in accordance with at least one embodiment. In this example, a first plurality of data chunks at a first level of detail associated with a first volumetric model within a shared partition is determined 722. For example, a bitset may be evaluated for a given LoD to determine an associated chunk. A plurality of shared features for a second volumetric model may be determined 724. The shared features may be associated with the first volumetric model and may correspond to the same data chunks. In at least one embodiment, a second plurality of data chunks at the level of detail of the second volumetric model may be mapped to at least a portion of the first plurality of data chunks 726. For example, the bitset for the given features may be used to identify the corresponding features for the associated chunks. As a result, different models may share data across partitions.

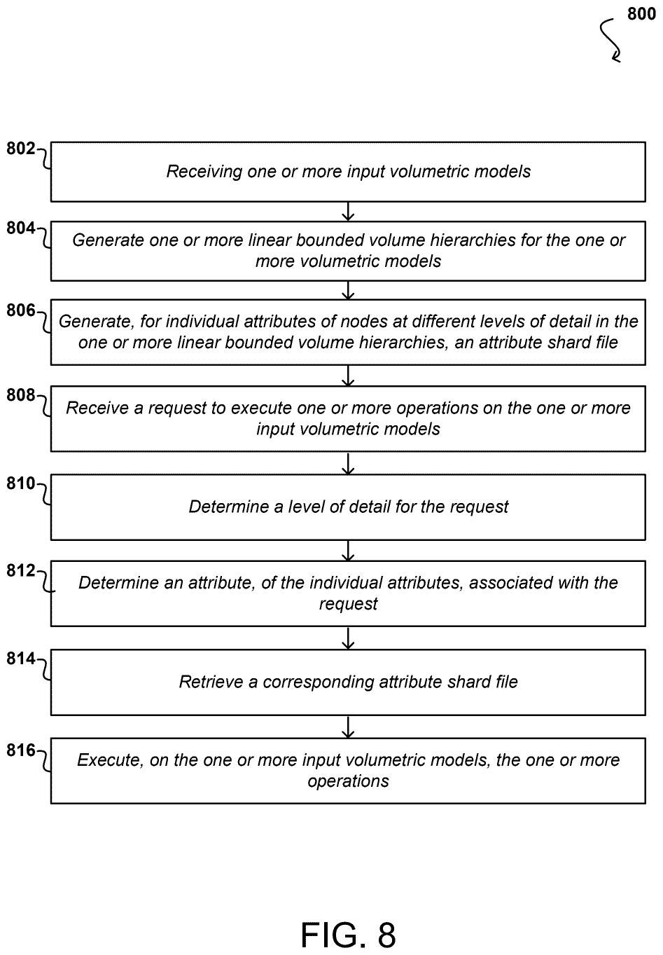

FIG. 8 illustrates an example process 800 that can be performed to execute operations on a subset of volumetric data, in accordance with at least one embodiment. In this example, one or more input volumetric models are received 802. In certain embodiments, a single model may be used and/or be sufficient to perform the one or more operations. However, in at least one embodiment, multiple models may be used, for example, to perform operations such as subtraction, merge, and the like. The one or more models may be used to generate one or more linear bounded volume hierarchies 804. For example, a tree structure may be generated that distributes the BVH into small shards. In at least one embodiment, an attribute shard file is generated 806 for individual attributes of nodes at different levels of detail in the linear BVH. For example, an attribute file may be generated for a particular attribute for all nodes at a given LoD. Any N number of attributes may be included and each may have an individual file so that rendering or operations may be performed on the attribute-level.

In at least one embodiment, a request is received to execute one or more operations on the one or more input volumetric models 808. The operations may include actions such as rendering or CSG operations, among others. In at least one embodiment, the request may include specific details or information for different portions of the operations. For example, a level of detail associated with the request may be determined 810 along with one or multiple attributes associated with the request 812. In at least one embodiment, the request may be associated with a particular operation for a given set of attributes, and as a result, providing the whole model may be computationally inefficient. One or more corresponding attribute shard files may be retrieved 814 and then the one or more operations may be executed 816. Accordingly, different actions may be particularly selected based on individual factors, thereby causing operations to have operation-level complexity, as opposed to model-level complexity.

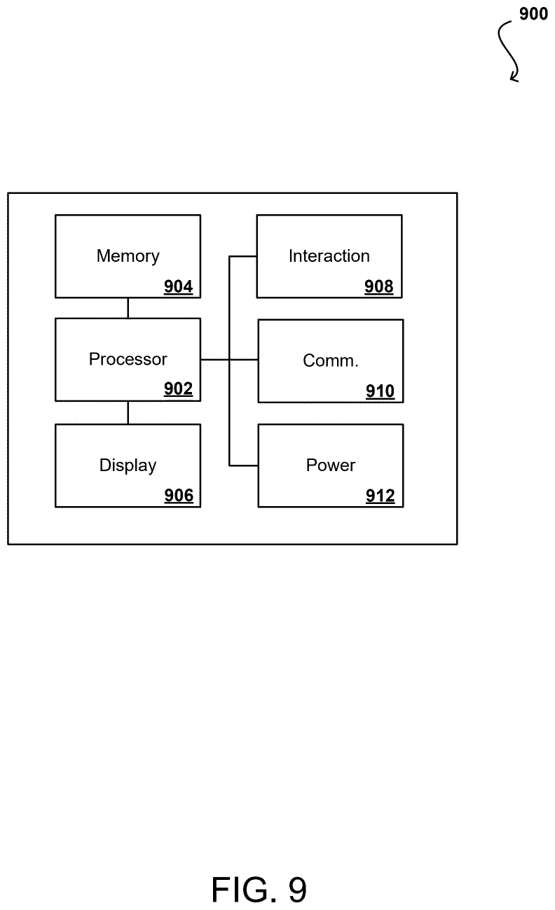

FIG. 9 illustrates a set of general components of an example computing device 900. In this example, the device includes a processor 902 for executing instructions that can be stored in a memory 904. The device can include many types of memory, data storage, or non-transitory computer-readable storage media, such as a first data storage for program instructions for execution by the processor 902, a separate storage for images or data, a removable memory for sharing information with other devices, etc. The device may optionally include a display element 906, such as a touch screen or liquid crystal display (LCD), although devices such as portable media players might convey information via other means, such as through audio speakers, and other devices may not include displays, such as server components executing within data centers, among other options. As discussed, the device in many embodiments will include at least one interaction component 908 able to receive input from a user. This input can include, for example, a push button, touch pad, touch screen, wheel, joystick, keyboard, mouse, keypad, or any other such device or element whereby a user can input a command to the device. In some embodiments, however, such a device might not include any buttons at all and might be controlled only through a combination of visual and audio commands, such that a user can control the device without having to be in contact with the device. In some embodiments, the computing device 900 of FIG. 9 can include one or more network interfaces or communication components 910 for communicating over various networks, such as Wi-Fi, Bluetooth, RF, wired, or wireless communication systems. The device may be configured to communicate with a network, such as the Internet, and may be able to communicate with other such devices. The device will also include one or more power components 912, such as power cords, power ports, batteries, wirelessly powered or rechargeable receivers, and the like.

Storage media and other non-transitory computer readable media for containing code, or portions of code, can include any appropriate media known or used in the art, including storage media and communication media, such as but not limited to volatile and non-volatile, removable and non-removable media implemented in any method or technology for storage of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store the desired information and which can be accessed by a system device. Based on the disclosure and teachings provided herein, a person of ordinary skill in the art will appreciate other ways and/or methods to implement the various embodiments.

Although the technology herein has been described with reference to particular embodiments, it is to be understood that these embodiments are merely illustrative of the principles and applications of the present technology. It is, therefore, to be understood that numerous modifications may be made to the illustrative embodiments and that other arrangements may be devised without departing from the spirit and scope of the present technology as defined by the appended claims.

What is claimed is:

1. A method, comprising:
receiving an input data set corresponding to a volumetric model generating a linear bounded volume hierarchy (BVH) from the input data set;
generating, for individual attributes of nodes at different levels of detail in the linear BVH, an attribute shard file;
receiving a request to execute one or more operations on a portion of the volumetric model;
determine, from the request, a geometric area of the portion of the volumetric model, a level of detail, and one or more attributes associated with the request;
retrieve one or more respective attribute shard files based on the one or more attributes;
and causing the one or more operations to be executed based on the one or more respective shard attribute files.

2. The method of claim 1, wherein the volumetric model includes an object represented by at least one of a block model, voxels, or a point cloud.

3. The method of claim 1, wherein the one or more attributes are represented by at least one of a string identification, a red, green, and blue (RGB), a boolean, or a scalar.

4. The method of claim 1, wherein the linear BVH is a tree structure, further comprising:
determining a tree height;
selecting a lowest level of detail;
permuting leaves to form a spatial partition; and
generating a parent node for the set.

5. The method of claim 1, wherein a child address within the linear BVH is implied from a parent address based on a branching factor and an offset.

6. The method of claim 1, wherein the one or more operations include at least one of a rendering operation or a computational solid geometry workload.

7. The method of claim 1, wherein at least two of the one or more attribute shard files are arranged within a common shared partition.

8. The method of claim 1, wherein the input volumetric model is an updated version of an original model that refers to the original model.

9. The method of claim 1, wherein the geometric area of the portion of the volumetric model is based on a virtual camera position.

10. A processor, comprising:
one or more circuits to:
generate a tree structure for a plurality of hierarchies corresponding to levels of detail for a volumetric model;
generate, at each level of the plurality of hierarchies, a plurality of shards corresponding to individual attributes for nodes of the volumetric model;
store the plurality of shards; and
provide, responsive to a request, a set of shards based on a selectively specified region of the volumetric model.

11. The processor of claim 10, wherein the one or more processing units are further to:
identify a first partition for a first portion of the plurality of shards;
identify a second partition for a second portion of the plurality of shards; and
cause the first portion of the plurality of shards to be stored in the first partition and the second portion of the plurality of shards to be stored in the second partition.

12. The processor of claim 10, wherein the tree structure includes a linear bounded volume hierarchy.

13. The processor of claim 10, wherein the request is associated with a request to render a portion of the volumetric model, wherein the one or more processing units are further to:
retrieve one or more shards of the plurality of shards associated with the portion of the volumetric model; and
cause the one or more shards to be streamed to a client device associated with the request.

14. The processor of claim 10, wherein the request is associated with a request to perform one or more constructive solid geometry operations between two models including at least one of intersection, union, merge, subtraction, cutting or filtering.

15. The processor of claim 10, wherein the volumetric model includes at least one of a block model, a point cloud, or a mesh.

16. The processor of claim 10, wherein the processor is comprised in at least one of:
a system for performing simulation operations;
a system for performing digital twin operations;
a system for rendering graphical output;
a system implemented at least partially in a data center; or
a system implemented at least partially using cloud computing resources.

17. A computer-implemented method, comprising:
generating a tree structure for a plurality of hierarchies corresponding to levels of detail for a volumetric model;
generating, at each level of the plurality of hierarchies, a plurality of shards corresponding to individual attributes for nodes of the volumetric model;
storing the plurality of shards; and
providing, responsive to a request, a set of shards based on a selectively specified region of the volumetric model.

18. The computer-implemented method of claim 17, further comprising:
identifying a first partition for a first portion of the plurality of shards;
identifying a second partition for a second portion of the plurality of shards; and
causing the first portion of the plurality of shards to be stored in the first partition and the second portion of the plurality of shards to be stored in the second partition.

19. The computer-implemented method of claim 17, wherein the tree structure includes a linear bounded volume hierarchy.

20. The computer-implemented method of claim 17, wherein the computer-implemented method is executed on at least one of:
a system for performing simulation operations;
a system for performing digital twin operations;
a system for rendering graphical output;
a system implemented at least partially in a data center;
a system for performing constructive solid geometry (CSG) operations; or
a system implemented at least partially using cloud computing resources.
